(19) United States
(12) Patent Application Publication
(10) Pub. No.: US 2010/0139244 A1
(43) Pub. Date: Jun. 10, 2010

(54) SELF-SUPPORTING MOUNT FOR CATALYST CARRIER BODY AND EXHAUST SYSTEM HAVING AT LEAST ONE MOUNT

(75) Inventors: Ludwig Wieres, Overath (DE); Michael Voit, Leverkusen (DE); Ferdi Kurth, Mechernich (DE)

Correspondence Address: LERNER GREENBERG STEMER LLP, P O BOX 2480, HOLLYWOOD, FL, 33022-2480, US

(73) Assignee: EMITEC GESELLSCHAFT FÜR EMISSIONSTECHNOLOGIE MBH, Lohmar (DE)

(21) Appl. No.: 12/632,020

(22) Filed: Dec. 7, 2009

(30) Foreign Application Priority Data
Dec. 5, 2008 (DE) 10 2008 060 787.8

(51) Int. Cl. F01N 3/00; F16M 13/00

(52) U.S. Cl. 60/272; 248/674

(57) ABSTRACT

A self-supporting mount for exhaust gas purification modules includes at least two retaining plates. The exhaust gas purification modules each have a cross sectional shape and at least one bead projecting beyond the main cross sectional shape and having a thickness. At least two of the exhaust gas purification modules pass at least partially through at least one of the retaining plates and are each fixed between the at least two retaining plates through the use of the bead. An exhaust system for a motor vehicle having at least one self-supporting mount, is also provided.

### CROSS-REFERENCE TO RELATED APPLICATION

This application claims the priority, under 35 U.S.C. §119, of German Patent Application DE 10 2008 060 787.8, filed Dec. 5, 2008; the prior application is herewith incorporated by reference in its entirety.

### BACKGROUND OF THE INVENTION

### Field of the Invention

The invention relates to a self-supporting mount for exhaust gas purification modules, which allows two or more exhaust gas purification modules carrying parallel flows to be disposed in an exhaust gas purification system. Such parallel flow-carrying configurations of exhaust gas purification modules are used, for example, in exhaust gas purification systems of commercial vehicles, in which the exhaust gas purification or emission control capacity of the exhaust gas purification system can be modularly adapted to the internal combustion engine and/or the exhaust gas production. The invention also relates to an exhaust system having at least one mount.

In the case of exhaust gas treatment in exhaust systems of mobile internal combustion engines, for example spark ignition and diesel engines, the aim nowadays is to treat exhaust gases in such a way that they can be emitted into the environment virtually entirely free of pollutants. The pollutants in the exhaust gas are generally converted in that case through the use of catalytically acting coatings, which are active at relatively low temperatures and assist the conversion of the pollutants. In that process it is desirable that the exhaust gases should remain in contact with the catalytic surfaces for as long as possible, since that affords a greater probability of the constituent pollutants reacting. For that purpose, in exhaust gas purification systems, the largest possible surface areas are provided with a catalytically acting coating.

At the same time, there is also an interest in achieving low overall volumes and a low flow resistance of the exhaust gas purification systems. Low overall volumes permit more advantageous use of the overall space available in the motor vehicle. Low flow resistances of the exhaust gas purification systems to the exhaust gas flowing through them have a positive effect on the power output of the internal combustion engine. In order to meet those requirements, exhaust gases in exhaust gas purification systems are generally brought into contact with exhaust gas purification modules having catalytic coatings. Exhaust gas purification modules are regularly embodied as honeycomb bodies, composed for example of twisted, wound or coiled, alternately corrugated and smooth metal foils. Alternatively, expanded or extruded ceramic honeycomb bodies are used. An outstanding feature of honeycomb bodies, particularly honeycomb bodies composed of thin metal foils, is their large internal surface for a low overall volume and relatively low flow resistances.

In order to meet the requirements with regard to the conversion of the exhaust gas, the pressure loss over the exhaust gas purification unit and the overall volume as fully as possible, there is a need for exhaust gas purification systems which are precisely suited in their capacity to the quantity of exhaust gas from the internal combustion engine. That is rendered all the more difficult by changing operating conditions of the internal combustion engine, which regularly occur in motor vehicles.

For that reason, consideration has already been given to placing a plurality of catalyst carrier bodies in a muffler, so as to arrive at an exhaust gas purification system of modular construction, in which the exhaust gas purification or emission control capacity can be adapted to the requirements of the motor vehicle. However, heretofore known parallel configurations of exhaust gas purification modules have been fitted in the actual exhaust system itself. That requires a considerable effort during assembly of the exhaust system, which gives rise to additional costs, especially since it should only be a matter of bringing larger sub-assemblies and components together at that stage in the assembly of an exhaust system.

### SUMMARY OF THE INVENTION

It is accordingly an object of the invention to provide a self-supporting mount for a catalyst carrier body and an exhaust system having at least one mount, which overcome the hereinafore-mentioned disadvantages and further alleviate the problems outlined in connection with the heretofore-known devices of this general type and which, in particular, demonstrate a cost-effective, self-supporting mount for a plurality of exhaust gas purification modules which, during final assembly of the exhaust gas purification system, for example, will entail a reduced assembly effort.

With the foregoing and other objects in view there is provided, in accordance with the invention, a self-supporting mount for exhaust gas purification modules each having a main cross sectional shape and at least one bead projecting beyond the main cross sectional shape and having a thickness. The self-supporting mount comprises at least two retaining plates. At least two of the exhaust gas purification modules each pass at least partially through at least one of the at least two retaining plates and is fixed between the at least two retaining plates by the beads.

The number of exhaust gas purification modules in the self-supporting mount according to the invention is optional. A manufacturer of exhaust gas purification modules, such as catalyst carrier bodies, filters, electrically heated honeycomb bodies and/or the like, for example, is therefore able to adapt to the manufacture of exhaust gas purification modules of specific sizes. In addition, he or she can produce retaining plates with different numbers of recesses (affording scope for a precise through-fit for each individual exhaust gas purification module). The production of various retaining plates having different numbers of recesses demands substantially less production engineering effort than the manufacture of a multiplicity of different exhaust gas purification modules. The manageable additional fitting step in assembling the self-supporting mounts according to the invention therefore enables a manufacturer to significantly reduce both the effort and the costs during the production of exhaust gas purification systems.

The number of exhaust gas purification modules in the self-supporting mount may be selected according to various criteria. A large number of exhaust gas purification modules having a low exhaust gas purification or emission control capacity may be provided in one self-supporting mount according to the invention in order to achieve a specific exhaust gas purification or emission control capacity. The option of such small exhaust gas purification modules also demands a greater fitting effort in assembling the self-supporting mount according to the invention. Larger exhaust gas purification modules reduce the number of exhaust gas purification modules which are needed in order to achieve a specific exhaust gas purification or emission control capacity in the self-supporting mount. At the same time, the exhaust gas purification or emission control capacity of the overall self-supporting mount can be adjusted less precisely.

Individual recesses in the retaining plates of the self-supporting mount can also be sealed with impervious cover plates, in order to achieve specific exhaust gas purification or emission control capacities without using different retaining plates for this purpose.

A cross-sectional shape is understood to mean, in particular, a primary basic shape of the exhaust gas purification module. Preferred cross-sectional shapes for this purpose are circular, oval and polygonal ones, a cross-sectional shape having an asymmetrical basic shape is most especially preferred, because it can be easily introduced into the mount with a definite orientation, that is with a form lock. A form-locking connection which connects two elements together due to the shape of the elements themselves, as opposed to a force-locking connection, which locks the elements together by force external to the elements.

The term bead, in particular, means that a radially outward-facing elevation projects beyond the cross sectional shape. The number of beads per exhaust gas purification module is preferably 1.

In principle, it is feasible for individual or all exhaust gas purification modules to pass through at least one of the two retaining plates, or even through both of them.

In order to carry out the fixing, the beads are preferably braced or clamped between the retaining plates. It is furthermore preferable for the beads to be embedded, for instance in a form-locking manner, in the retaining plates, with any clamping forces being in the main exerted solely through the retaining plates. The fixing is therefore, in particular, releasable but if necessary it can be achieved by additional welded connections or brazed connections in exceptional cases.

The self-supporting mount according to the invention is particularly advantageous if at least one exhaust gas purification module has at least one housing, on which the bead is disposed (in particular integrally or in one piece) and in which a honeycomb body is provided. Such a housing may be provided with a bead, for example by deep-drawing. It is also possible to provide a bead at the end of the housing or to construct a housing in two parts from two housing sections, with both housing sections being provided with a collar at one end and these two collars together forming the bead, which is form-lockingly fixed between the two retaining plates.

It is furthermore advantageous if the honeycomb body is constructed solely from at least partially structured metal layers (sheet metal, lattice, netting or knitted fabric, web, fleece or mat, etc.), for example from corrugated metal foils and smooth metal foils, and these, at least partially, are (alternately) coiled, wound or stacked in such a way that channels are formed. Such metal exhaust gas purification modules can be used to particular advantage in self-supporting mounts according to the invention. The production of such exhaust gas purification modules is more economical in large quantities. For this reason the use of a multiplicity of smaller catalyst carrier bodies in one exhaust system, as is required by the mount according to the invention, is justifiable. In addition, such exhaust gas purification modules (for example catalyst carrier bodies or particle separators) are often adjusted in order to generate turbulent internal flows. For this purpose, they have a wide variety of internal baffle surfaces. In order to be able to actually achieve turbulent flows in the exhaust gas purification module, certain minimum volumetric flows through the exhaust gas purification modules may be necessary. For this reason, the configuration according to the invention is of great advantage in the context of exhaust gas purification modules having a turbulent through-flow.

In accordance with another feature of the invention, self-supporting mounts according to the invention are particularly advantageous if the bead of the exhaust gas purification modules at least has a circumferential construction or extends around or projects entirely beyond the cross-sectional shape of at least two exhaust gas purification modules. However, the bead preferably embodies both features. A form-locking fixing of the exhaust gas purification modules in the self-supporting mount according to the invention is in principle also possible if the bead projects only partially beyond the cross-sectional shape. In the case of a bead running radially around the entire circumference, however, the exhaust gas purification module and the retaining plate can at the same time be sealed off from one another, preventing any flow around the exhaust gas purification module.

In accordance with a further feature of the invention, it is moreover advantageous if at least one spacer is provided, which forms a space between at least two retaining plates. This space can be adapted to the thickness of the bead on the exhaust gas purification module. It may be either precisely equal thereto or also somewhat smaller. In this way, it is possible to set a defined pressure of the bead between the two retaining plates.

In accordance with an added feature of the invention, it is also advantageous if at least two retaining plates are connected together through the use of releasable fasteners. Configuring the self-supporting mount according to the invention in such a way that the fasteners of the two retaining plates are releasable allows for non-destructive dismantling. This in turn affords the possibility of replacing defective individual exhaust gas purification modules without having to replace the entire self-supporting mount. This can mean a considerable cost advantage when servicing exhaust systems. Releasable fasteners may include, in particular, bolted connections or the like.

In accordance with an additional feature of the invention, it is also possible according to the invention to place at least two exhaust gas purification modules offset in relation to one another on at least two retaining plates. Such configurations permit exhaust systems of compact construction. Asymmetrically shaped exhaust gas purification modules are especially suitable for such configurations. For example, hexagonal exhaust gas purification modules can be disposed in a tightly packed pattern on a retaining plate. However, circular cross-sectional shapes of catalyst carrier bodies can also be disposed relatively tightly. An “offset” configuration, in particular, means that the centers of the exhaust gas purification modules are not disposed all on one line, and in particular that the adjacent exhaust gas purification modules are disposed in a pattern (for example a polygon). A tight configuration is achieved particularly when the centers of adjacent exhaust gas purification modules are disposed at a distance from one another, which is less than the maximum extent of the cross-sectional shape or which at least approximates it very closely.

With the objects of the invention in view, there is concomitantly provided an exhaust system for a motor vehicle having an internal combustion engine, comprising at least one self-supporting mount according to the invention. In this case, the mount is positioned, for example, between pipe sections of the exhaust pipe transversely to the direction of flow, so that the flow of exhaust gas can preferably pass through all exhaust gas purification modules in parallel. If desired, multiple retaining plates of this type can also be disposed in series, for example with different exhaust gas purification modules (possibly oxidation catalytic converters followed by particle traps then SCR catalytic converters, etc.). In this case, the exhaust gas purification modules of the various retaining plates are oriented in alignment with one another. It is also possible, where desired, to place at least one reducing agent adding device and/or flow mixer or the like between (or on) these retaining plates.

Other features which are considered as characteristic for the invention are set forth in the appended claims, noting that the features itemized in the claims may be combined with one another in any technologically suitable way and may be supplemented by explanatory matter in the description, setting forth further variant embodiments of the invention.

Although the invention is illustrated and described herein as embodied in a self-supporting mount for a catalyst carrier body and an exhaust system having at least one mount, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, longitudinal-sectional view of a first variant of an embodiment of the invention, in which an exhaust gas purification module passes through two retaining plates;

FIG. 2 is a view similar to FIG. 1 of a variant of an embodiment of the invention, in which an exhaust gas purification module passes through one retaining plate;

FIG. 3 is an end-elevational view of an especially advantageous compact configuration of the exhaust gas purification modules on a retaining plate;

FIG. 4 is a cross-sectional view of an exhaust gas purification module having a wound catalyst carrier body for a device according to the invention; and

FIG. 5 is a plan view of a motor vehicle having a device according to the invention.

### DETAILED DESCRIPTION OF THE INVENTION

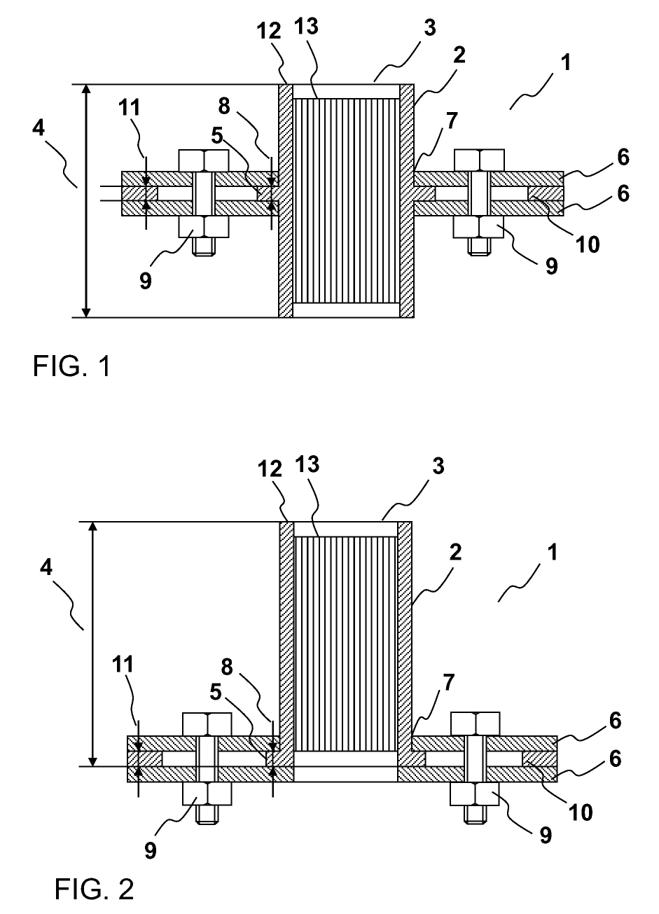

Referring now to the figures of the drawings in detail and first, particularly, to FIG. 1 thereof, there is seen a portion of a self-supporting mount 1 according to the invention, in which an exhaust gas purification module 2 is shown. The exhaust gas purification or emission control module 2 (for example a catalyst carrier body or a particle separator or a multifunctional exhaust treatment unit), having a cross-sectional shape 3 and a length 4, passes through two retaining plates 6. The exhaust gas purification module 2 in this case has a bead 5 with a thickness 8. The exhaust gas purification module 2 passes through recesses 7 in the retaining plates 6. The bead 5 is form-lockingly fixed between the two retaining plates 6. A spacer 10, which creates a space 11 between the two retaining plates 6, is also provided. Fasteners 9, which in this case take the form of bolts, hold the self-supporting mount 1 together. The exhaust gas purification module 2 is constructed with a housing 12 and a honeycomb body 13 disposed therein.

FIG. 2 likewise shows a portion of a self-supporting mount 1 according to the invention, in which an exhaust gas purification module can be seen. In this case the exhaust gas purification module 2 passes through only one of the two retaining plates 6 and is fixed between them by its bead 5 and its thickness 8. In this case too, a spacer 10, which creates a space 11 between the two retaining plates 6, is provided. The two retaining plates 6 are likewise connected together through the use of fasteners 9 and thus hold the self-supporting mount 1 according to the invention together. The exhaust gas purification module provided in this case also has a housing 12, a honeycomb body 13 disposed therein and a length 4.

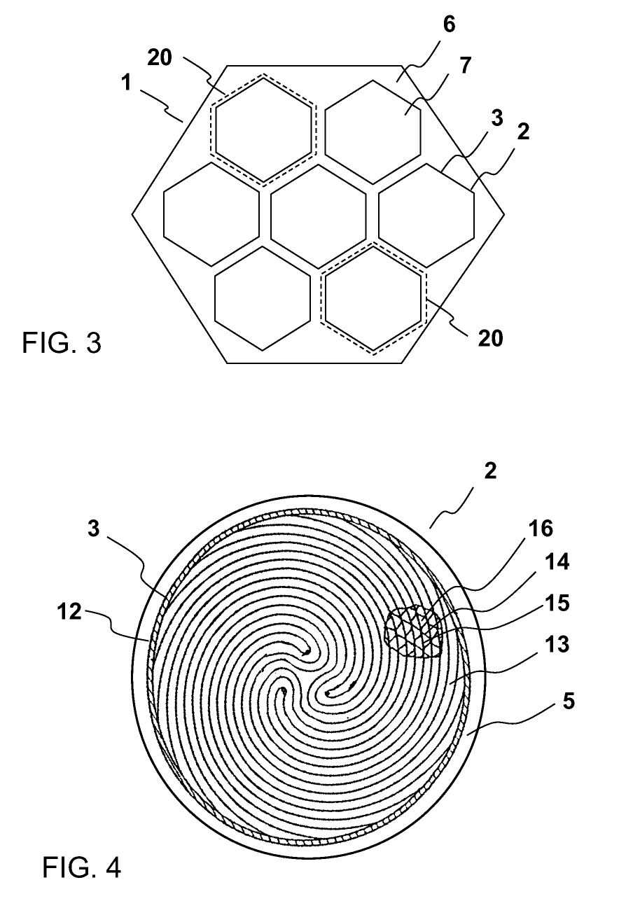

FIG. 3 shows a particularly compact configuration of exhaust gas purification modules 2 having a hexagonal cross-sectional shape 3 in a self-supporting mount 1 according to the invention. The recesses 7 of the retaining plate 6 are in this case disposed in such a way that a space-saving configuration of the exhaust gas purification modules 2 results. A hexagonal cross-sectional shape 3 is particularly suitable for such a compact configuration. Individual recesses 7 can be sealed through the use of cover plates 20, in order to achieve a precise adjustment of the gas exhaust purification or cleaning capacity of the self-supporting mount 1 according to the invention, without having to keep different retaining plates 6 with recesses 7 in stock. The adjacently disposed exhaust gas purification modules are in this case positioned with their substantially flat side faces parallel to one another, so that in each case a gap of a few millimeters is formed, for example a gap of less than 30 mm or even less than 15 mm. In so doing, for example, a packing density can be achieved, so that more than 90% or possibly even more than 95% of the area subjected to the exhaust gas flow is encountered on the inlet end face of the exhaust gas purification modules. In service, an unwanted high back-pressure of the exhaust gas can thereby be avoided.

FIG. 4 shows an exhaust gas purification module 2, which is particularly suited to the device according to the invention. The exhaust gas purification module 2 has a circular cross section 3. The exhaust gas purification module 2 includes a housing 12, which is furnished with a bead 5 and a honeycomb body 13 is disposed therein. The honeycomb body 13 is wound from corrugated metal foils 14 and smooth metal foils 15 in such a way as to form channels 16 for passage of the exhaust gas.

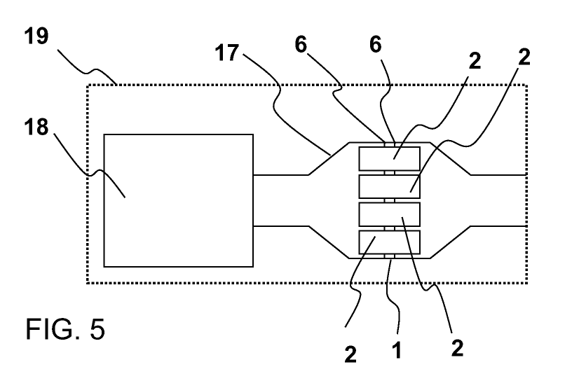

FIG. 5 shows a motor vehicle 19 having an internal combustion engine 18, which is constructed with an exhaust system 17. In the exhaust system 17, provision is made for a self-supporting mount 1, which holds a plurality of exhaust gas purification modules 2 in parallel in the exhaust gas flow, through the use of retaining plates 6. At least 10 exhaust gas purification modules or even at least 18 exhaust gas purification modules are preferably incorporated into the self-supporting retaining plate 1.

The self-supporting mount according to the invention affords a particularly simple embodiment of exhaust gas purification, cleaning or emission control configurations which is advantageous from a production engineering standpoint and which can be adapted to the widely varying requirements for exhaust systems of motor vehicles, without the need to manufacture many different types of catalyst carrier bodies.

1. A self-supporting mount for exhaust gas purification modules each having a main cross sectional shape and at least one bead projecting beyond the main cross sectional shape and having a thickness, the self-supporting mount comprising:
at least two retaining plates;
at least two of the exhaust gas purification modules each passing at least partially through at least one of said at least two retaining plates and being fixed between said at least two retaining plates by the beads.

2. The self-supporting mount according to claim 1, wherein the beads of the exhaust gas purification modules extend at least around or project entirely radially beyond the main cross sectional shape of the at least two exhaust gas purification modules.

3. The self-supporting mount according to claim 1, wherein at least one of said retaining plates has a spacer forming a space between said at least two retaining plates.

4. The self-supporting mount according to claim 1, which further comprises releasable fasteners interconnecting said at least two retaining plates.

5. The self-supporting mount according to claim 1, wherein the at least two exhaust gas purification modules are disposed offset relative to one another on said at least two retaining plates.

6. An exhaust system for a motor vehicle having an internal combustion engine, the exhaust system comprising:
at least one self-supporting mount according to claim 1.

7. An exhaust gas purification system, comprising:
exhaust gas purification modules each having a main cross sectional shape and at least one bead projecting beyond said main cross sectional shape and having a thickness; and
a self-supporting mount having at least two retaining plates;
at least two of said exhaust gas purification modules each passing at least partially through at least one of said at least two retaining plates and being fixed between said at least two retaining plates by said beads.
